(19) United States
(12) Patent Application Publication
(10) Pub. No.: US 2004/0256406 A1
(43) Pub. Date: Dec. 23, 2004

(54) Manually operated pill dispenser

(76) Inventor: Wellesley Alexander Allen, Cambridge (CA)

Correspondence Address: Wellesley A. Allen, 1216 Avonlea Road, Cambridge, ON, N3H 4Z8, CA

(21) Appl. No.: 10/633,359

(22) Filed: Aug. 4, 2003

(30) Foreign Application Priority Data
Jun. 10, 2003 (CA) 2,430,936

(51) Int. Cl. G07F 11/00

(52) U.S. Cl. 221/69

(57) ABSTRACT

In this invention the improved manually operated pill dispenser is manufactured from a suitable plastic material which comprises wraparound embossed characters on the walls for illustrations, a series of notches and ridges around the top periphery shaped like the cross section of a square thread pointing downwards, each notch is aligned with the chambers and a closing port lid. The lid comprising an indexing tab, a lip, a hollow plastic tube, or a suitable plastic bubble to provide a spring-like and an alignment indicator adjacent to the indexing tab and dispensing hole: when engaged and rotated may align the hole with the chamber or the closing port. Rotation may only be achieved when pushed down. The underside of the dispenser is constructed with multiple lid adapters; one to interlock with its self as well as to host its own interlocking stacking containers and other for existing pill bottles of varying sizes.

### BACKGROUND OF THE INVENTION

Manually operated pill dispensers have been around for decades they come in different shapes and sizes and usually are manufactured from a suitable plastic material. It is common in device for manually operated pill dispensers to be of the flip top or slide top access variety. They serve as a metering device, a reminding device, a safe traveling device, a skipped dose or double dose prevention device, a device that answers to all needs relating to pill dispensing: May it be a weeks metering supply or several weeks supply. Unfortunately each dispenser has some of these features but none with all the features. Dispensers of this type prove to be inefficient and unreliable, they pop open inadvertently causing confusion in dosage taking to the user. The task to access the rheumatoid arthritic conditions with limited fine motor ability. This invention may include most, if not all the features of prior art in one new and improved manually operated dispenser. Typically some are shown for example, in the following North American patents:

| | |
|---|---|
| USO5052584 | USO3788517 |
| USO5909822 | USO5915560 |
| USO3885703 | USO5154296 |
| U.S. Pat. No. 3638830 | U.S. Pat. No. 3889847 |

Although most manually operated pill dispensers have achieved some measure of success and commercial popularity, there is still a continuing need for improvement and this invention by definition is futuristic with the cross section of users including amputees, and users with physical limitations.

### BRIEF SUMMARY OF THE INVENTION

I have found that these disadvantages maybe overcome by providing a manually operated pill dispenser with a spring loaded lid with a dispensing hole mirrored to that of the dispensing chambers and an indexing tab. The dispenser comprises of 28 dispensing chambers representing seven days of the week, four chambers per day having embossed labeling, abbreviations of breakfast time—BRK., lunch time—LUN., supper time—SUP., and bedtime—BDT. The top periphery of the dispenser is constructed with a series of raised ridges and notches shaped like the cross section of a square thread pointing downwards. The depth area is aligned with each chamber, and when the lid is engaged with the dispenser and rotated one notch to the right, the chambers will be enclosed and every notch thereafter will be aligned with a chamber starting with Sunday BRK. Rotation may only be achieved when the lid is pushed down, and will retract and lock in place to access each chamber when the pressure is released. The palm of the hand maybe used as well as the fingers as this is not an option found in other pill dispensing designs. Having the combined dispenser being interlocking with each other may also appeal to a broader cross section of users including, amputees, medical institutions, caregivers, long term chronic pill users, users with arthritic conditions, travelers, vacationers, anglers, and others. This particular design in its simple or base form allows for seven days supply of several pills per day, but additional dispensers may be coupled together to facilitate several more days, weeks or even months as the needs of each individual dictates. Just one dispensing lid is required per several coupled units.

Considered broadly dispensers, according to the invention, are of the manual type, comprised a plurality of radially constructed holding chambers on top to hold a collection of pills in each, and a blind space between the first and last weekdays that serves as a closing port. Each chamber is aligned with a time abbreviation within a weekday and each weekday is divided into 4 equal time segments: Breakfast Time, Lunch Time, Supper Time, and Bed Time, abbreviated: BRK, LUN, SUP, BDT. These abbreviations will be embossed vertically on the outer periphery of the dispenser walls, including raised embossment at the top periphery of the chambers shaped like the cross section of a square thread pointing downwards. The depth area is strategically aligned with each chamber forming a series of raised notches and ridges around the top. Each letter of the weekday is also embossed axially on the dispenser walls immediately under the vertical embossment: BRK, LUN, SUP, BDT. This combination is essential to the process of the operation. Advantageously the combined construction may be molded from a suitable plastic material. The hollow plastic tube may be fitted to the lid or may be molded as part of the fabrication or maybe replaced with a plastic plate of suitable flexibility to provide the required spring action. The manufacturing process maybe blow or injection mold, or a combination of both.

### BRIEF DESCRIPTION OF THE SEVERAL VIEWS OF THE DRAWINGS

A—Lid

B—Dispenser Holding Chambers

C—Stacking Container

D—Bottom Container

FIG. 1a—Lid—A

1— Indexing or Locking Tab

2— Dispensing Hole

3— Alignment or Assembly Indicator

4— Bottom Lip

FIG. 1b-Hollow Plastic Tube

13— Hole for Retraction or Spring Action

FIG. 2a-Dispenser

3— Embossed Ridges and Notches

4— Dispensing Chambers

5a—Blind Space or Closing Port

5b—Vertically Abbreviated Embossment

6— Alignment or Assembly Indicator

7— Axially Embossed Characters of Weekdays

FIG. 2b-Host for Stacking Containers and Adapters for Existing Pill Bottles Underside of FIG. 2a

6— Alignment or Assembly Indicator

8a—Lids for Existing Pill Bottles

9a—Assembly or Locking Tab for the Host Containers

9—Assembly or Locking Tab for Existing Pill Bottles

10—Labeling

FIG. 3a—Stacking Container Male End

10—Labeling

11a—Embossed Ridges and Notches Modeled to that of the Dispenser

FIG. 3b—Stacking Container Female End

5—Alignment or Assembly Indicator

9a—Stacking Container Locking or Assembly Tab Female End

11a—Assembly Port Male End

14—Lip

FIG. 4—Bottom Stacking Container Male End

10—Labeling

11a—Assembly Port Male End, Container Male End

11b—Embossed Ridges and Notches, Container Male End

12—Bottom Container without the Female End

FIG. 5—Exploded View With all the Above Combined

FIG. 6—Cut Away View, With all the Above Combined

1—Indexing or Locking Tab, Dispenser

2—Dispensing Hole

3—Embossed Ridges and Notches, Dispenser

4—Dispensing Chamber

5a—Blind Space or Closing Port

5b—Vertical Abbreviated Embossment

6—Alignment or Assembly Indicator

7—Axially Embossed Characters of Weekdays

8a—Lid for Host Containers

8b—Lids for Existing Pill Bottles

9—Assembly or Locking Tab for Existing Pill Bottles

9a—Assembly or Locking Tab for Host Containers

10—Labeling

11a—Assembly Port Male End

11b—Embossed Ridges and Notches, Container Male End

12—Bottom Container Without the Male End

13—Hollow Plastic Tube

14—Tip

### DETAILED DESCRIPTION OF THE INVENTION

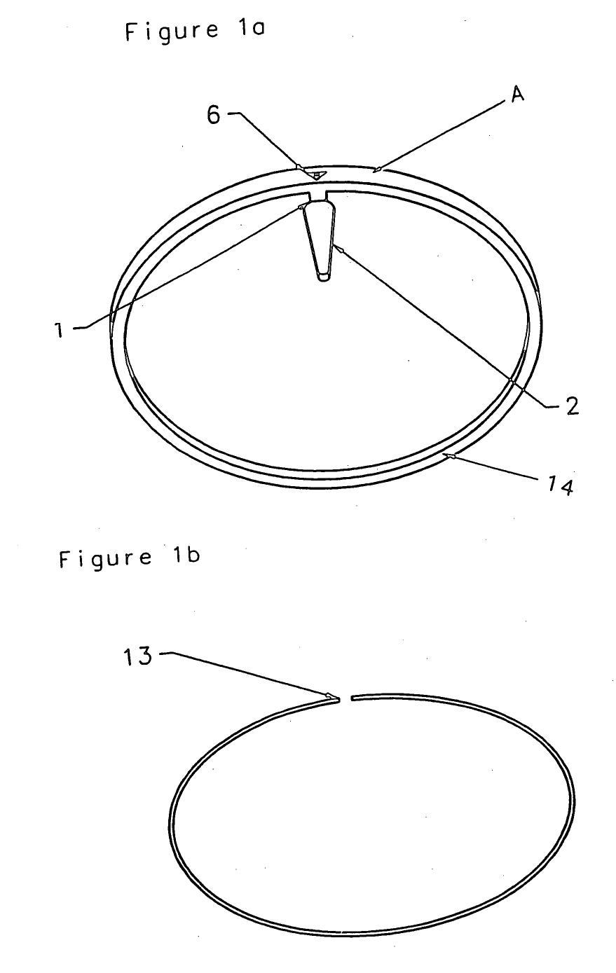

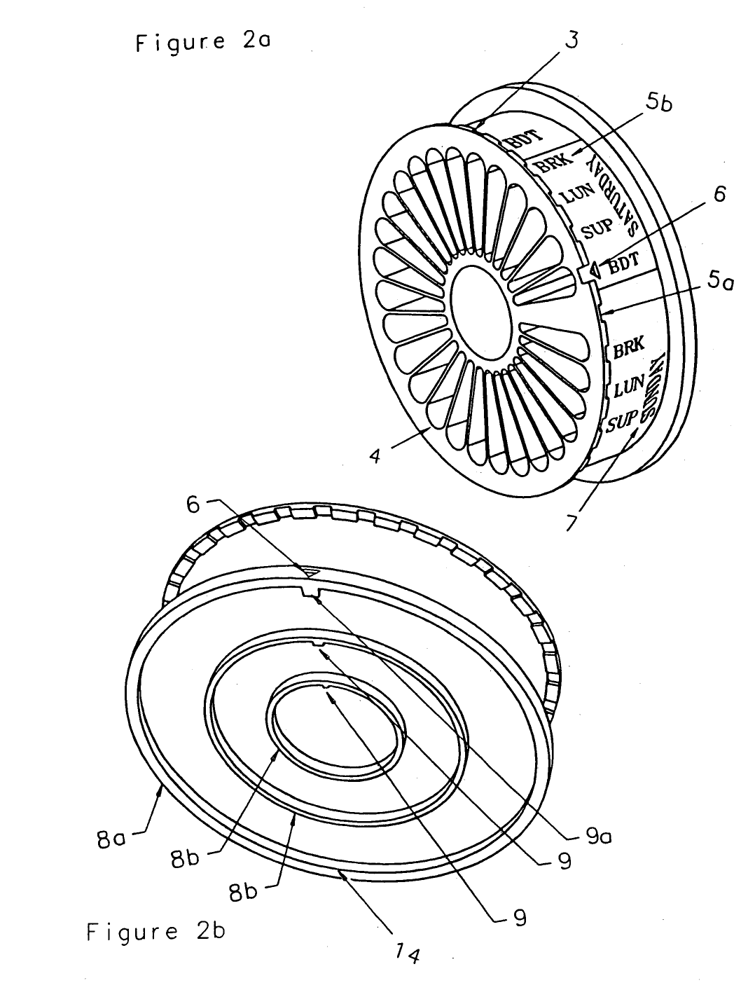

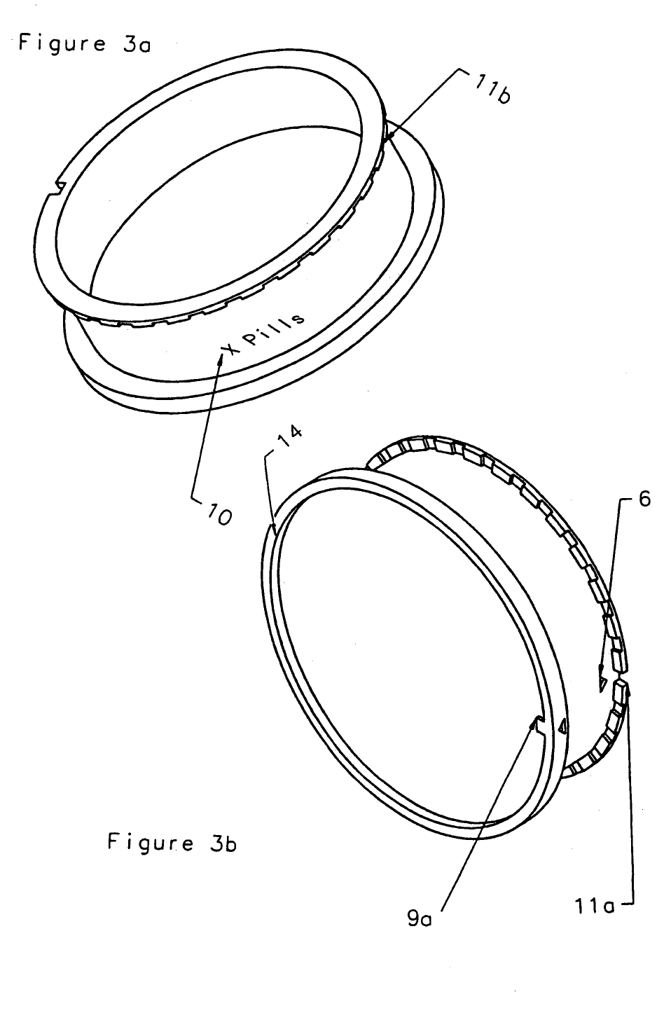

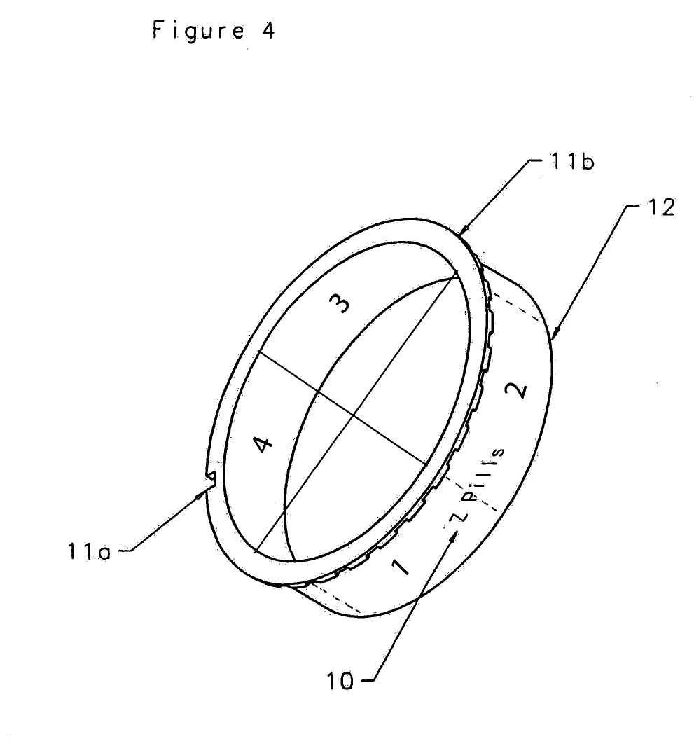

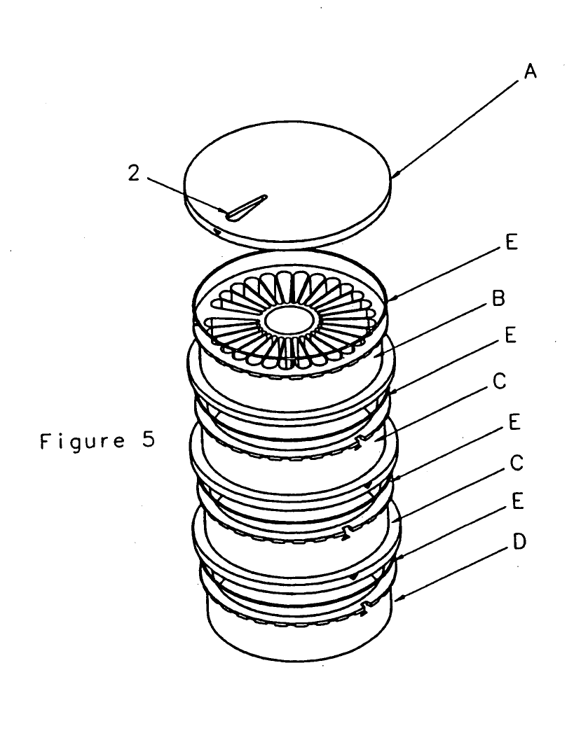

In the drawing which forms part of the specification, FIG. 1a and FIG. 1b shows a three dimensional view of a lid and a hollow plastic tube. According to one embodiment of the invention as claimed. The best angle was chosen to show all of the important features including the dispensing hole FIG. 1a2, the indexing or locking tab FIG. 1a1, the alignment indicator 1a6 and the bottom lip figure 1a14, and FIG. 1b13 is the hollow plastic tube with a gap for installation and spring-like retraction. FIG. 2a is a 3 dimensional view of the pill dispenser, the invention as claimed shows most if not all of the important features from the top and side elevations. FIG. 2a3, indexing notches, FIG. 2a4 dispensing chambers, FIG. 2a5a notch to blind space, FIG. 2a5b embossed abbreviations on the side walls. FIG. 2a6, alignment indicator, and FIG. 2a7 axial embossment of each days of the week. FIG. 2b, is a 3 dimensional view of the underside of FIG. 2a. The invention as claimed shows most if not all of the important features of the bottom and side views including the alignment indicator on the side walls, the notches of the top periphery, the multiple lid adapters on the bottom, and the locking tabs. FIG. 3a, is a 3 dimensional view of the top and side elevation of the stacking containers. The invention as claimed shows the best view of inside the container and the outside top periphery of the male end of the container. FIG. 3a is a 3 dimensional view showing a stacking container. The invention as claimed shows the best views of the underside of FIG. 3a including a bottom lip FIG. 3a14 and an indexing or locking tab FIG. 3a9a, this is the female end of the container. FIG. 4 is a 3 dimensional view of the bottom container without the female end. The invention shows all the features of FIG. 3a without the female end at the bottom. FIG. 5 is a 3 dimensional exploded view of the combined dispenser. The invention shows the best view of the lid with the dispensing hole, hollow plastic tube, alignment indicator, holding chambers and stacking containers. FIG. 6 is a 3 dimensional sectional cut away view. The invention shows the combined dispenser assembled.

In the particular advantageous embodiments of the invention illustrated pill dispenser, the lid FIG. 1a, comprises an indexing or locking tab FIG. 1a1 that is slightly smaller than the notches of FIG. 2a3 that when engaged may align the dispensing chambers and prevent inadvertent rotation. Advantageously, a dispensing hole FIG. 1a2 that is mirrored to that of the dispenser may give access to the chamber and its contents when aligned, a hollow plastic tube FIG. 1b13 may be fitted to the inside top periphery of the lid FIG. 1bA or a suitable corrugated plastic plate not shown, to provide a spring-like action advantageous to the functions of the dispenser. It allows the lid to retract and lock in the notch when pressure is released. Either feature may be included in the fabrication or may be fitted. The dispenser FIG. 2a comprises a main body having ridges and notches 3, holding or dispensing chambers 4, blind space or closing port 5a, vertically embossed abbreviated characters 5b, alignment and assembly indicator 6, axially embossed characters spelling each day of the week day 7, advantageously when lid FIG. 1a A-6 is engaged with FIG. 2a6 and rotate 1 notch to the right which is the blind space or closing port between chambers of Sunday and Saturday the top of the dispenser will be closed off and each consecutive notch thereafter will be aligned with a chamber. Advantageously, each chamber is aligned with vertically embossed raised characters of either BRK, LUN, SUP, BDT which occupies the axially embossed spelling space of each week day Sunday through Saturday on the walls just below the abbreviations and 90 (to the vertical embossment of FIG. 2a7. Advantageously it may be necessary to construct the lip FIG. 1a14 with the same configuration of that of the ridges and notches but slightly smaller FIG. 2a3, to allow the lid to retract at each notch rotation for indexing and locking and to provide the right amount of interference for push off without compromising its other features. Advantageously FIG. 2b shows the underside of the dispenser 2a which comprises the construction of the multiple lid feature FIG. 8a and FIG. 8b. The largest FIG. 8a to be host for its stacking containers FIG. 3a and 3b. The FIG. 3a11b and FIG. 3b11a is modeled to that of the dispenser and the lid without the dispensing hole, these stacking containers have 4 equal sections to hold up to 4 different prescription of pills. By resort this style may offer more to the invention economically and commercially. FIG. 3a10 and FIG. 4, 10 shows a space for labeling. FIG. 3b9a shows a locking tab which is advantageous for the purpose of child proofing. FIG. 4 12 shows the bottom container without the female end and FIG. 5 shows the exploded view of the dispenser together with 3 stacking containers including the bottom container FIG. 4 12 without the female end. The dispenser lid is labeled A, and the dispenser hole is labeled 2, and the hollow plastic tube is labeled E, the dispensing holding chamber is labeled B, the stacking containers with the male and female end is labeled C, the bottom container without the female end is labeled D. The cut away view FIG. 6 shows a cross section of the combined assembly. It will be apparent that some changes and modifications can be made without departing from the scope of the invention as defined is claim 8 where a hollow plastic tube FIG. 1b may be substituted for a suitable plastic plate, also the symmetry of the combined configuration, or where FIG. 1a, A6 is engaged with FIG. 2a6 and rotate one notch to the right. Illustration example of a possible operation. If your physician prescribes 4 pills per day starting Sunday, advantageously you would firstly place a pill in each of the 28 chambers, secondly engage the lid to the dispenser, thirdly depress and rotate to access your first pill in the chamber aligned wit Sunday BRK, then LUN, SUP, and BDT. And this process of operation may be repeated daily for 7 days. Once the required doses are placed in the chambers and the lid is engaged it may not be removed again until the cycle is complete. Once the chamber is accessed and the contents removed the dispenser may remain in that mode until the next dosage. Should you realize you have missed a dose or doses remove them from the chambers as soon as possible thereafter and continue to the next. At the completion of rotation cycle the dispenser should be empty in its entirety. This possible problem is taken into consideration in the decision to construct the lid direction of travel in both ways instead of one. This may eliminate the chance of going to the push off point where the lid is likely to come off inadvertently.

The embodiments of the invention in which an exclusive property of privilege is claimed or as defined as follows:

I. Th invention as claimed, an improved manually operated pill dispenser, the lid assembly combination comprising a dispensing hole on top, a hollow plastic tube fitted to the inside top as shown, or other corrugated plastic to provide a spring-like action, an indexing tab at the inside bottom and an alignment indicator on the outside wall in front of the hole on top of the indicating tab to engage with the dispenser and to align the hole with each chamber. The dispenser comprises in combination a plurality of radially constructed chambers on top to hold and dispense a collection of pills, including a blind space, an alignment indicator and a raised embossment at the top periphery of the chambers shaped like th cross section of a square thread pointing downwards the depth area creating notches and ridges around the periphery in alignment with each chamber. The periphery walls are also embossed with raised characters spelling out each weekday Sunday to Saturday, the space occupying the spelling is divided into 4 equal time segments each representing the abbreviations of Breakfast BRK, Lunch LUN, Supper SUP, Bedtime BDT, the abbreviations a re constructed vertically in alignment with each chamber, and each notch is aligned with a chamber, the underside is constructed with multiple lid adapters the larger lid is modeled to that of the dispensing lid without the hole to host a plurality of stacking containers each having a male and female end including one without the female end for the bottom, and the others modeled to adopt existing pill bottles of varying sizes, it is so arranged that the lid combination indexes in a notch at the blind space which engages the lid to the dispensing chambers and encloses its contents, each consecutive notch around the periphery thereafter is aligned to a chamber.

II. The invention as claimed, an improved manually operated pill dispenser of claim 1 where in the lid assembly combination and the dispenser are molded from a suitable plastic material whereby various colors may be added to the construction for better clarity.

III. The invention as claimed, an improved manually operated dispenser of claim 2 wherein the dispenser comprises in combination a plurality of radially constructed chambers on top to hold and dispense a collection of pills.

IV. The invention as claimed, an improved manually operated dispenser of claim 3 wherein the chamber comprises a blind space that serves as a closing port between the start and finishing chambers.

V. The invention as claimed, an improved manually operated dispenser of claim 4 wherein the underside of the dispenser comprises a construction of multiple lid adapters, the largest is modeled to that of the dispensing lid without the hole to host its own stacking containers.

VI. The invention as claimed, an improved manually operated dispenser of claim 5 wherein the stacking containers comprises a male and female end that is modeled to that of the top periphery of the dispenser and the dispensing lid without the hole to interconnect with each other and to the dispenser.

VII. The invention as claimed, an improved manually operated dispenser of claim 5 and 6 wherein the other lids are constructed to adopt existing pill bottles of varying sizes.

VIII. The invention as claimed, an improved manually operated dispenser of claim 2 and 7 wherein the lid construction comprises a hollow plastic tube or a suitable corrugated plastic plate or plastic bubble to provide a spring-like action to retract the lid and lock it in place.

IX. The invention as claimed, an improved manually operated dispenser of claim 2 and 8 wherein the lid construction comprises a suitable plastic plate or other suitable means to provide a spring-like action to retract the lid and lock it in place.

X. The invention as claimed, an improved manually operated dispenser of claim 4 and 9 wherein the construction of the dispenser walls comprises an embossment of axially raised characters labeling the days of the week to assist in the illustrations of the functions.

XI. The invention as claimed, an improved manually operated dispenser of claim 10 wherein the construction of the dispenser walls comprises an embossment of vertically raised characters abbreviated BRK, LUN, SUP, BDT, each abbreviation is aligned with a chamber to assist in the illustration of the functions.

XII. The invention as claimed, an improved manually operated dispenser of claim 3 and 11 wherein the top periphery of the dispenser comprise raised notches shaped like the cross section of a square thread pointing downwards, the depth is aligned with each chamber to effect a precise indexing and locking when the lid engages the dispenser and rotate.

XIII. The invention as claimed, an improved manually operated dispenser of claim 12 wherein the dispenser comprises interlocking features that allows them to be coupled together at both ends.

XIV. The invention as claimed, an improved manually operated dispenser of claim 6 and 13 wherein the bottom stacking container comprises only a male end so it sits flat.

XV. The invention as claimed, an improved manually operated dispenser of claim 14 wherein the dispenser could be fitted with a coil spring in the center as part of the safety mechanism that may prevent the user from skipping or doubling their daily doses because of the process of operation it allows to access each chamber. Push down, rotate, retract and lock.

XVI. The invention as claimed, an improved manually operated dispenser of claim 15 wherein the design may prove to be advantageous to users with limitations in dexterity of motion including amputees.

XVII. The invention as claimed, an improved manually operated dispenser of claim 16 whereby resort this invention may provide a reliable means for vacationers and travelers to apportionately meter a supply of pills for their trip.

XVIII. The invention as claimed, an improved manually operated dispenser of claim 17 which may also serve as a means of prepackaging medication before getting it to the consumer.

XIX. The invention as claimed, an improved manually operated dispenser of claim 18 may also be used by fishermen and anglers for various applications.

XX. The invention as claimed, an improved manually operated dispenser of claim 1 through 19 wherein the lid assembly could be permanently attached yet rotatable and therefore allowing the entire unit to be stackable using the same method of operation described before.

XXI. The invention as claimed, an improved manually operated dispenser of claim 1 through 20 wherein the dispenser in whole or in part could be fixed with an electronic device which would allow it to send off certain signals which would help some users with audio or visual impairment.
